(19) United States
(12) Patent Application Publication
(10) Pub. No.: US 2025/0203391 A1
(43) Pub. Date: Jun. 19, 2025

(54) Increasing Spectral Efficiency in Beam-Forming Cellular Communication Networks

(71) Applicant: Rakuten Symphony, Inc., Tokyo (JP)

(72) Inventors: Vijayakumar Yalamalli, Bangalore (IN); Vihang Kamble, Weybridge (GB); Raghavendra Madanahally Ramakrishna, Bangalore (IN); Pallavi Srinivasa Alse, Bangalore (IN)

(21) Appl. No.: 18/540,114

(22) Filed: Dec. 14, 2023

(51) Int. Cl. H04W 16/28; H04B 7/06

(52) U.S. Cl. CPC H04W 16/28; H04B 7/0617; H04B 7/0696

(57) ABSTRACT

A node of a cellular communication network is coupled to a beam-forming antenna defining a plurality of directions. For each beam direction, the node determines a usage requirement and a priority of each item of user equipment of items of user equipment within each beam direction. The node select a selected beam direction of the at least the portion of the plurality of beam directions according to aggregations of the usage requirement and the priority of each item of user equipment within each beam direction. The aggregation may be of a spectral usage metric that is a combination of the priority and usage requirement. The aggregation may be of a shortlist of items of equipment within each direction selected based on the spectral usage metrics thereof.

### BACKGROUND

### Field of the Invention

This invention relates to increasing spectral efficiency in beam-forming cellular communication networks.

### Background of the Invention

Cellular communication networks rely on the ability to re-use the electromagnetic spectrum repeatedly throughout the network. Specifically, the range of signals transmitted within a first cell is limited such that a second, non-neighboring cell may transmit and receive signals using the same frequencies as the first cell without creating significant interference. The re-use of the electromagnetic spectrum is further enhanced by using beam-forming. Beam-forming includes using an array of antennas to generate a narrow beam directed to user equipment located within the range and angular extent of the beam. Beam-forming reduces interference with neighboring cells.

### SUMMARY OF THE INVENTION

In one aspect of the invention, a system includes a beam-forming antenna configured to transmit beams in a plurality of beam directions. The system further includes a node of a cellular communication network, the node coupled to the beam-forming antenna. The node is configured to, for each beam direction of at least a portion of the plurality of beam directions, determine a usage requirement and a priority of each item of user equipment of items of user equipment within each beam direction. The node is further configured to select a selected beam direction of the at least the portion of the plurality of beam directions according to aggregations of the usage requirement and the priority of each item of user equipment within each beam direction. The node then causes the beam-forming antenna to point in the selected beam direction and transmit data to the user equipment within the selected beam direction using the beam-forming antenna.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a diagram illustrating user equipment in a cellular communication network using beam-forming;

FIG. 2 is a process flow diagram for calculating a spectral usage metric in accordance with an embodiment;

FIG. 3 is a process flow diagram of a method for selecting a beam direction based on spectral usage metrics in accordance with an embodiment; and

FIG. 4 is a schematic block diagram of an example computing device suitable for implementing methods in accordance with embodiments according to the disclosure.

### DETAILED DESCRIPTION

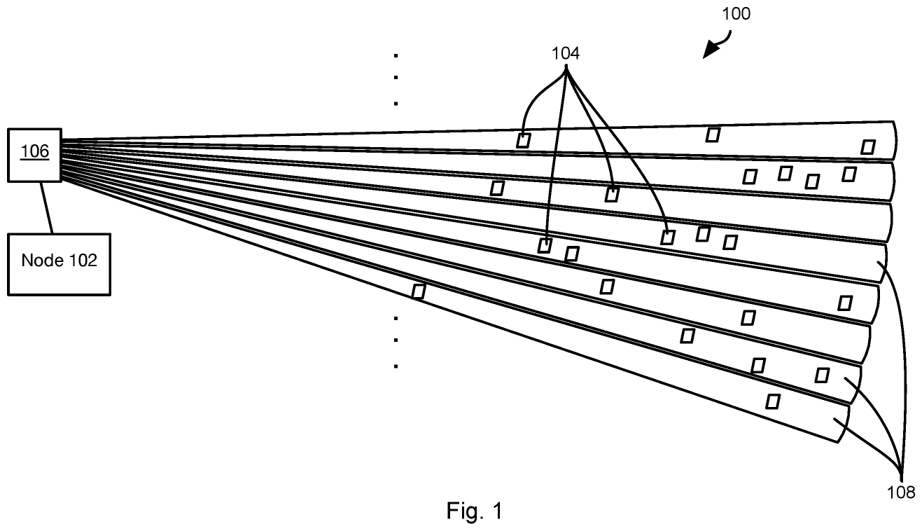

FIG. 1 illustrates an example cellular communication network 100 in which a node 102 establishes radio connections to a plurality of items of user equipment (UE) 104. The node 102 may be a computing device configured to manage radio communication, such as a gNodeB or eNodeB. Each UE 104 may be implemented as a mobile phone or other device capable of cellular radio communication with the node 102. The node 102 may use a beam-forming antenna 106, such as a millimeter wave analog beam-forming antenna. The beam-forming antenna 106 may define a plurality of discrete directions 108 along which the beam-forming antenna 106 may direct a beam. Each direction 108 may have a corresponding index, such as a synchronization signal block (SSB) index according to the fifth generation/new radio (5G/NR) standard. When the beam from the beam-forming antenna 106 is directed along a particular direction, a certain number of UEs 104 will be located within the angular extent and range of the beam such that the UE 104. As used herein a UE 104 is “within” a direction 108 when the UE 104 is able to have an active radio connection to the beam-forming antenna 106 when the beam is directed in the direction 108. The manner in which a UE 104 is determined by the node 106 to be located within a given direction 108 may be performed using any approach known in the art.

The node 106 may communicate simultaneously with multiple UEs 104 by allocating one or more frequency channels to each UE 104 located in a given direction 108. Each UE 104 located in a direction 108 may be assigned a slot representing one or more frequency bands, and a time slot, e.g., 0.5 seconds. For example, each slot may be a physical resource block (PRB) according to the 5G/NR standard. Within a slot assigned to a UE, the node 106 transmits data to the UE 104, such as packets including voice data or network communication data.

In prior approaches, the allocation of slots to UE 104 was performed based on the priorities of all UEs 104 connected to a node 106 regardless of the direction 108 within which each UE 104 is located. The priority of a UE 104 is based on factors such as the amount of data previously sent to the UE 104, a signal equality of a connection to the UE 104 (e.g., reference signal receive power (RSRP) or reference signal receive quality (RSRQ)).

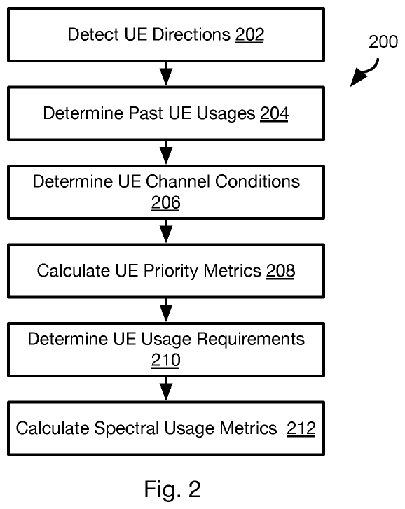

Referring to FIG. 2, in the approach described herein, slots are assigned to a beam index based on spectral usage metric for UEs 104 for each beam index. For example, a method 200 may be executed by the node 102 with respect some or all UEs 104 connected to the node 102, (hereinafter “the UEs 104”). The approach by which UEs 104 connect to the node 102 may be according to any approach, such as according to the 3G, 4G, 5G, or LTE standards.

The method 200 includes detecting 202 directions 108 for the connected UEs 104. For example, each UE 104 may be assigned to an index for the direction 108 within which the UE 104 is located, such as an SSB index. The approach by which the direction 108 for each UE 104 is determined may be according to any approach, such as according to the 3G, 4G, 5G, or LTE standards.

The method 200 may include determining 204 past usage for each UE 104. Past usage may include a time since data was last transmitted to or from the UE 104 and an amount of data in the last transmission. The method 200 may include determining 206 channel conditions for each UE 104, such as reference signal receive power (RSRP), reference signal receive quality (RSRQ), or other measure of channel quality. The method 200 may include calculating 208 a priority metric for each UE 104. The Priority metric may be calculated 208 based on the past usage and channel conditions from steps 204 and 206. The priority metric may be calculated according to any approach for implementing a proportional fair scheduling approach known in the art of cellular communication.

The method 200 may include determining 210 usage requirements for each UE 104. For example, step 210 may include determining an amount of data stored in a buffer to be sent to the UE 104. The amount of data may be measured in the form of memory (bytes, kilobytes, Megabytes, etc.) or in terms of slots (e.g., PRB) required to transmit the data.

The method 200 may include calculating 212 a spectral usage metric for each UE 104. The spectral usage metric for a UE 104 may be a function of the priority metric and the usage requirement for the UE 104. For example, a product, sum, weighted sum, or some other function of the priority metric and the usage requirement.

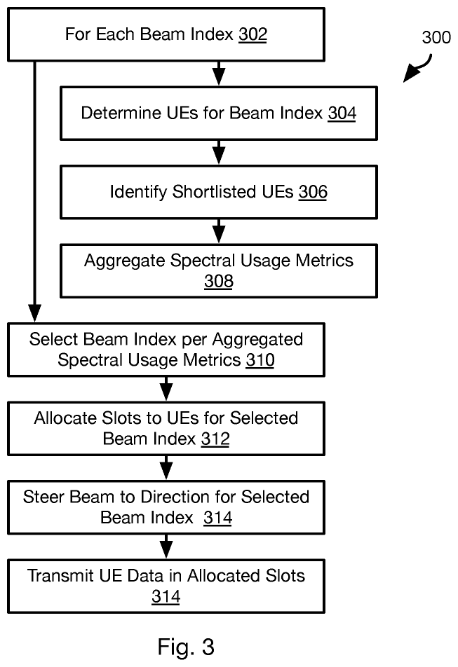

FIG. 3 illustrates a method 300 that may be executed by the node 102 following or along with performing the method 200. Specifically, the method 300 may use the spectral usage metrics for the UEs 104. The method 300 may include, iteratively processing 302 each beam index. For example, processing 302 each beam index may include determining 304 the UEs 104 for the each beam index, i.e., each UE 104 located within the direction 108 corresponding to the each beam index. The node 102 may determine the direction 108 for each UE 104 using any approach known in the art of cellular communication.

Processing 302 may include identifying 306 shortlisted UEs for the each beam index. The shortlisted UEs 104 for each beam index may be those with the highest spectral usage metrics. For example, suppose that the beam is capable of allocating N slots, where N is the total number of slots, and each slot corresponds to a carrier frequency band or a group of carrier frequency bands. Each slot has a duration measured in timesteps (e.g., from 5 to 25 milliseconds). Each slot may have a duration of a single timestep or may include M consecutive timesteps, where M is one or larger. The shortlisted UEs 104 may be added to the shortlist in order of decreasing spectral usage metrics until the aggregation of the usage requirements (see step 210, described above) of the UEs 104 in the shortlist is equal to or greater than X*N*M slots, where X is a value greater than or equal to one, such as two or greater. The value of X is a scaling factor that is greater than one and is selected to increase the probability that the usage requirements will be sufficient to fill all of the available N*M slots. For example, there may be conflicts that require that transmission of data for some UEs 104 cannot be scheduled simultaneously. The conflicts may be determined according to any approach known in the art of cellular communication. The value of X being greater than one therefore accounts for the possibility of such conflicts.

Processing 302 may further include aggregating 308 the spectral usage metrics for the UEs 104 for the each beam index to obtain an aggregated spectral usage metric for the each beam index. Step 308 may include aggregating only the spectral usage metrics for the shortlisted UEs 104 for the each beam index to obtain the aggregated spectral usage metric. Aggregating 306 may include summing the spectral usage metrics. Aggregating 306 may include obtaining some other statistical characterization of the spectral usage metrics, such as an average, median, maximum, or other statistical characterization.

The method 300 may include selecting 310 a selected beam index from the beam indexes of the node 102. For example, step 310 may include selecting the beam index having the highest aggregated spectral usage metric.

The method 300 may include allocating 312 slots to the UEs 104 for the selected beam index as determined at step 304, such as to the shortlisted UEs 104 for the selected beam index. The slots may be PBRs for M time steps following performing the method 300. Allocating 312 the slots may take into account any requirements of the cellular communication, which may include taking into account conflicts that prohibit simultaneously allocating slots to two different UEs 104. Allocating 312 may proceed by allocating slots to the UEs 104 in order of decreasing spectral usage metric until all the slots are filled.

The method 300 may then include causing the beam-forming antenna 106 to steer 314 the beam to the direction 108 corresponding to the selected beam index and transmitting 314 the data of the UEs 104 within the slots as allocated at step 312.

The method 300 may then be repeated for the next M−1 time steps, where M is the number of time steps in each slot, which may simply be one in some embodiments.

The methods 200 and 300 provide for improved spectral usage. In prior approaches, devices are selected individually based on priority. However, since the beam can only point in one direction for a given time step, some, if not most, of the spectral bandwidth of the beam may be unused. Using the approach described herein, the spectral usage metric for the UEs 104 for a given beam index is used to select a beam index. Since the spectral usage metric is a function of both the priority and the usage requirement of each UE 104, the probability of using all of the slots for a given time step is increased while still tending to avoid excessive or insufficient allocations to individual UEs as indicated by the priority.

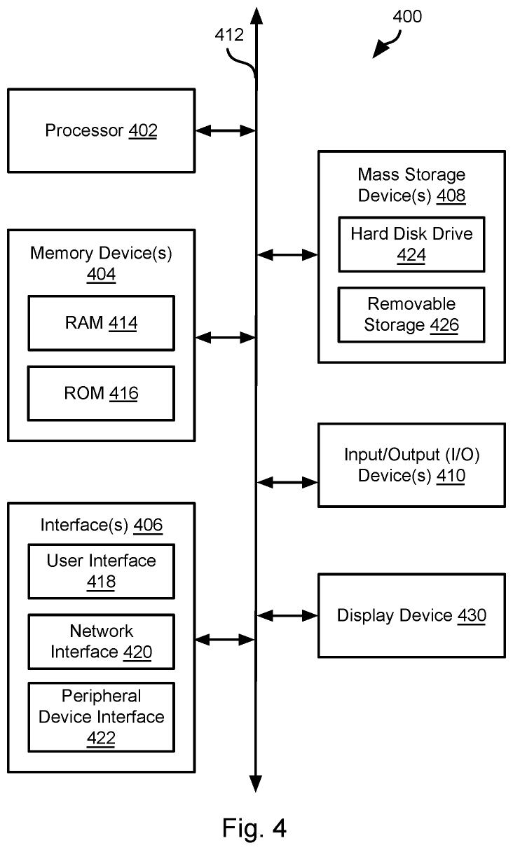

FIG. 4 is a block diagram illustrating an example computing device 400. Computing device 400 may be used to perform various procedures, such as those discussed herein. The node 102 and each UE 104 may have some or all of the attributes of the computing device 400.

Computing device 400 includes one or more processor(s) 402, one or more memory device(s) 404, one or more interface(s) 406, one or more mass storage device(s) 408, one or more Input/output (I/O) device(s) 410, and a display device 430 all of which are coupled to a bus 412. Processor(s) 402 include one or more processors or controllers that execute instructions stored in memory device(s) 404 and/or mass storage device(s) 408. Processor(s) 402 may also include various types of computer-readable media, such as cache memory.

Memory device(s) 404 include various computer-readable media, such as volatile memory (e.g., random access memory (RAM) 414) and/or nonvolatile memory (e.g., read-only memory (ROM) 416). Memory device(s) 404 may also include rewritable ROM, such as Flash memory.

Mass storage device(s) 408 include various computer readable media, such as magnetic tapes, magnetic disks, optical disks, solid-state memory (e.g., Flash memory), and so forth. As shown in FIG. 4, a particular mass storage device is a hard disk drive 424. Various drives may also be included in mass storage device(s) 408 to enable reading from and/or writing to the various computer readable media. Mass storage device(s) 408 include removable media 426 and/or non-removable media.

I/O device(s) 410 include various devices that allow data and/or other information to be input to or retrieved from computing device 400. Example I/O device(s) 410 include cursor control devices, keyboards, keypads, microphones, monitors or other display devices, speakers, printers, network interface cards, modems, lenses, CCDs or other image capture devices, and the like.

Display device 430 includes any type of device capable of displaying information to one or more users of computing device 400. Examples of display device 430 include a monitor, display terminal, video projection device, and the like.

Interface(s) 406 include various interfaces that allow computing device 400 to interact with other systems, devices, or computing environments. Example interface(s) 406 include any number of different network interfaces 420, such as interfaces to local area networks (LANs), wide area networks (WANs), wireless networks, and the Internet. Other interface(s) include user interface 418 and peripheral device interface 422. The interface(s) 406 may also include one or more peripheral interfaces such as interfaces for printers, pointing devices (mice, track pad, etc.), keyboards, and the like.

Bus 412 allows processor(s) 402, memory device(s) 404, interface(s) 406, mass storage device(s) 408, I/O device(s) 410, and display device 430 to communicate with one another, as well as other devices or components coupled to bus 412. Bus 412 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 400, and are executed by processor(s) 402. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

In the above disclosure, reference has been made to the accompanying drawings, which form a part hereof, and in which is shown by way of illustration specific implementations in which the disclosure may be practiced. It is understood that other implementations may be utilized and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Implementations of the systems, devices, and methods disclosed herein may comprise or utilize a special purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links, which can be used to carry desired program code means in the form of computer-executable instructions or data structures and which can be accessed by a general purpose or special purpose computer. Combinations of the above should also be included within the scope of computer-readable media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, an in-dash vehicle computer, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the description and claims to refer to particular system components. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a sensor may include computer code configured to be executed in one or more processors, and may include hardware logic/electrical circuitry controlled by the computer code. These example devices are provided herein purposes of illustration, and are not intended to be limiting. Embodiments of the present disclosure may be implemented in further types of devices, as would be known to persons skilled in the relevant art(s).

At least some embodiments of the disclosure have been directed to computer program products comprising such logic (e.g., in the form of software) stored on any computer useable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments, but should be defined only in accordance with the following claims and their equivalents. The foregoing description has been presented for the purposes of illustration and description. It is not intended to be exhaustive or to limit the disclosure to the precise form disclosed. Many modifications and variations are possible in light of the above teaching. Further, it should be noted that any or all of the aforementioned alternate implementations may be used in any combination desired to form additional hybrid implementations of the disclosure.

1. A system comprising:
a beam-forming antenna configured to transmit beams in a plurality of beam directions; and
a node of a cellular communication network, the node coupled to the beam-forming antenna and configured to:
for each beam direction of at least a portion of the plurality of beam directions, determine a usage requirement and a priority of each item of user equipment of items of user equipment within each beam direction;
select a selected beam direction of the at least the portion of the plurality of beam directions according to aggregations of the usage requirement and the priority of each item of user equipment within each beam direction;
causing the beam-forming antenna to point in the selected beam direction; and
transmitting data to the user equipment within the selected beam direction using the beam-forming antenna.

2. The system of claim 1, wherein the usage requirement includes an amount of buffered data.

3. The system of claim 1, wherein the priority of each item of user equipment is a function of past usage and channel conditions.

4. The system of claim 1, wherein the node is further configured to:
for each item of user equipment, calculate a spectral usage metric as a function of the priority and the usage requirement of each item of user equipment;
for each beam direction of the at least the portion of the plurality of beam directions, aggregate the spectral usage metrics for the items of equipment within each beam direction to obtain an aggregated spectral usage metric for each beam direction; and
select the selected beam direction as having a highest aggregated spectral usage metric of the at least the portion of the plurality of beam directions.

5. The system of claim 1, wherein the node is further configured to:
for each item of user equipment, calculate a spectral usage metric as a function of the priority and the usage requirement of each item of user equipment;
for each beam direction of the at least the portion of the plurality of beam directions:
select a shortlist of the items of user equipment within each beam direction based on the spectral usage metrics thereof;
aggregate the spectral usage metrics for the shortlist to obtain an aggregated spectral usage metric for each beam direction; and
select the selected beam direction as having a highest aggregated spectral usage metric of the at least the portion of the plurality of beam directions.

6. The system of claim 5, wherein the node is further configured to select the shortlist of the items of user equipment within each beam direction as both of (a) having highest aggregated spectral usage metrics of the items of user equipment within each beam direction and (b) having an aggregated usage requirement at least equal to X*M*N, where X is a value greater than 1, M is a number of time steps, and N is a number of slots available for transferring data per time step using the beam-forming antenna.

7. The system of claim 6, wherein X is greater than or equal to 2.

8. The system of claim 6, wherein the slots are physical resource blocks (PBR).

9. The system of claim 1, wherein the beam-forming antenna is an analog beam-forming antenna.

10. The system of claim 9, wherein the beam-forming antenna is a millimeter wave beam-forming antenna.

11. A method comprising:
for each beam direction of at least a portion of a plurality of beam directions for a beam-forming antenna, determining, by a node of a cellular communication network, a usage requirement and a priority of each item of user equipment of items of user equipment within each beam direction;
selecting, by the node, a selected beam direction of the at least the portion of the plurality of beam directions according to aggregations of the usage requirement and the priority of each item of user equipment within each beam direction;
causing, by the node, the beam-forming antenna to point in the selected beam direction; and
transmitting, by the node, data to the user equipment within the selected beam direction using the beam-forming antenna.

12. The method of claim 11, wherein the usage requirement includes an amount of buffered data.

13. The method of claim 11, wherein the priority of each item of user equipment is a function of past usage and channel conditions.

14. The method of claim 11, further comprising:
for each item of user equipment, calculating, by the node, a spectral usage metric as a function of the priority and the usage requirement of each item of user equipment;
for each beam direction of the at least the portion of the plurality of beam directions, aggregating, by the node, the spectral usage metrics for the items of equipment within each beam direction to obtain an aggregated spectral usage metric for each beam direction; and
selecting, by the node, the selected beam direction as having a highest aggregated spectral usage metric of the at least the portion of the plurality of beam directions.

15. The method of claim 11, further comprising:
for each item of user equipment, calculating, by the node, a spectral usage metric as a function of the priority and the usage requirement of each item of user equipment;
for each beam direction of the at least the portion of the plurality of beam directions:
selecting, by the node, a shortlist of the items of user equipment within each beam direction based on the spectral usage metrics thereof;
aggregating, by the node, the spectral usage metrics for the shortlist to obtain an aggregated spectral usage metric for each beam direction; and
selecting, by the node, the selected beam direction as having a highest aggregated spectral usage metric of the at least the portion of the plurality of beam directions.

16. The method of claim 15, further comprising selecting, by the node, the shortlist of the items of user equipment within each beam direction as both of (a) having highest aggregated spectral usage metrics of the items of user equipment within each beam direction and (b) having an aggregated usage requirement at least equal to X*M*N, where X is a value greater than 1, M is a number of time steps, and N is a number of slots available for transferring data per time step using the beam-forming antenna.

17. The method of claim 16, wherein X is greater than or equal to 2.

18. The method of claim 16, wherein the slots are physical resource blocks (PBR).

19. The method of claim 11, wherein the beam-forming antenna is an analog beam-forming antenna.

20. The method of claim 19, wherein the beam-forming antenna is a millimeter wave beam-forming antenna.
